(19) United States
(12) Patent Application Publication
(10) Pub. No.: US 2024/0120878 A1
(43) Pub. Date: Apr. 11, 2024

(54) PHOTOVOLTAIC ROOF TILE CONNECTION CONFIGURATION

(71) Applicant: Tesla, Inc., Austin, TX (US)

(72) Inventors: Bhavananda Reddy NADIMPALLY, San Mateo, CA (US); Ehsan RISMANIYAZDI, San Jose, CA (US); Mykola PASHKEVYCH, Fremont, CA (US)

(21) Appl. No.: 18/540,518

(22) Filed: Dec. 14, 2023

Related U.S. Application Data
(63) Continuation of application No. PCT/US2022/034308, filed on Jun. 21, 2022.
(60) Provisional application No. 63/213,622, filed on Jun. 22, 2021.

(51) Int. Cl. H02S 40/34; E04D 1/30; H02S 20/25; H02S 40/36

(52) U.S. Cl. CPC H02S 40/34; E04D 1/30; H02S 20/25; H02S 40/36; E04D 2001/308

(57) ABSTRACT

A configuration for electrically coupling photovoltaic roof tiles together is described herein. Specific embodiments for describing redundant connections between the photovoltaic roof tiles are described. In particular, a junction box on each photovoltaic roof tile includes two cable terminals that are electrically coupled together by a diode. One of the cable terminals is electrically coupled to two cables that run in parallel to a junction box on another photovoltaic roof tile and is also coupled to internal circuitry of the photovoltaic roof tile. The diode allows the internal circuitry to be bypassed through a bypass cable for safety purposes.

### CROSS-REFERENCE TO RELATED APPLICATIONS

The present application is a continuation of PCT Application No. PCT/US2022/034308, entitled “PHOTOVOLTAIC ROOF TILE CONNECTION CONFIGURATION,” filed on Jun. 21, 2022, which claims priority to U.S. Provisional Application Ser. No. 63/213,622, entitled “PHOTOVOLTAIC ROOF TILE CONNECTION CONFIGURATION,” filed Jun. 22, 2021. The contents of each of these applications are hereby incorporated by reference in their entireties.

### BACKGROUND

### Field

This disclosure is generally related to photovoltaic roof tiles. More specifically, this disclosure describes a configuration for electrically coupling junction boxes of adjacent photovoltaic roof tiles together.

### Related Art

In residential and commercial solar energy installations, a building's roof typically is installed with photovoltaic (PV) modules, also called PV or solar panels, that can include a two-dimensional array (e.g., 6×12) of solar cells. A PV roof tile (or solar roof tile) can be a particular type of PV module offering weather protection for the home and a pleasing aesthetic appearance, while also functioning as a PV module to convert solar energy to electricity. The PV roof tile can be shaped like a conventional roof tile and can include one or more solar cells encapsulated between a front cover and a back cover, but typically encloses fewer solar cells than a conventional solar panel.

The front and back covers can be fortified glass or other material that can protect the PV cells from the weather elements. Note that a typical roof tile may have a dimension of 15 in×8 in=120 in²=774 cm², and a typical solar cell may have a dimension of 6 in×6 in=36 in²=232 cm². Wiring and connectors for these solar cells can be complex and require intensive labor during installation. For at least this reason, improvements in wiring and connector configurations are desirable.

### SUMMARY

One embodiment can provide a photovoltaic roof tile. The photovoltaic roof tile can have the cosmetic appearance of multiple roof tiles and be configured to be mechanically and electrically coupled to other photovoltaic roof tiles.

A respective photovoltaic roof tile is disclosed and can include a photovoltaic roof tile that includes a protective cover; a backsheet; multiple solar cells disposed between the protective cover and the backsheet, the solar cells comprising a first electrical terminal proximate a first end of the photovoltaic roof tile and a second electrical terminal proximate a second end of the photovoltaic roof tile; a first junction box adhered to a roof-facing surface of the backsheet, the first junction box comprising: a first cable terminal comprising a first end electrically coupled to the first electrical terminal and a second end electrically coupled to a first electrical lead and a second electrical lead configured to receive electrical energy in parallel from an adjacent photovoltaic roof tile; a second cable terminal; and a diode electrically coupling the first cable terminal to the second cable terminal; a second junction box adhered to the roof-facing surface of the backsheet, the second junction box comprising a third cable terminal electrically coupled to the second electrical terminal and configured to receive electrical energy generated by the plurality of solar cells; and a bypass cable comprising a first cable end at the second cable terminal and a second cable end at the third cable terminal.

A photovoltaic roof is disclosed and can include a photovoltaic roof, comprising: a first photovoltaic roof tile comprising a first junction box; a second photovoltaic roof tile adjacent to the first photovoltaic module, the second photovoltaic roof tile comprising: a second junction box; a third junction box; and a diode, wherein internal circuitry of the second photovoltaic roof tile electrically couples a first cable terminal within the second junction box to a second cable terminal within the third junction box; a first cable electrically coupling the first junction box to the second junction box; a second cable electrically coupling the first junction box to the second junction box in parallel with the first cable; and a third cable electrically coupling the second junction box to the third junction box, wherein the diode directs electrical energy received from the first junction box at the second junction box across the third cable when an electrical voltage at the second junction box exceeds a predetermined threshold value.

A “solar cell strip,” “photovoltaic strip,” “smaller cell,” or “strip” is a portion or segment of a photovoltaic structure, such as a solar cell. A photovoltaic structure may be divided into a number of strips. A strip may have any shape and any size. The width and length of a strip may be the same or different from each other. Strips may be formed by further dividing a previously divided strip.

“Finger lines,” “finger electrodes,” and “fingers” refer to elongated, electrically conductive (e.g., metallic) electrodes of a photovoltaic structure for collecting carriers.

“Busbar,” “bus line,” or “bus electrode” refer to elongated, electrically conductive (e.g., metallic) electrodes of a photovoltaic structure for aggregating current collected by two or more finger lines. A busbar is usually wider than a finger line, and can be deposited or otherwise positioned anywhere on or within the photovoltaic structure. A single photovoltaic structure may have one or more busbars.

A “photovoltaic structure” can refer to a solar cell, a segment, or a solar cell strip. A photovoltaic structure is not limited to a device fabricated by a particular method. For example, a photovoltaic structure can be a crystalline silicon-based solar cell, a thin film solar cell, an amorphous silicon-based solar cell, a polycrystalline silicon-based solar cell, or a strip thereof.

### BRIEF DESCRIPTION OF THE FIGURES

FIG. 1 shows an exemplary configuration of PV roof tiles on a house.

FIG. 2 shows a perspective front view of an exemplary photovoltaic roof tile, according to an embodiment.

FIG. 3A shows an exemplary configuration of a multi-tile module, according to one embodiment.

FIG. 3B shows a cross-section of an exemplary multi-tile module, according to one embodiment.

FIG. 4A illustrates a serial connection among three adjacent cascaded photovoltaic strips, according to one embodiment.

FIG. 4B illustrates a side view of the string of cascaded strips, according to one embodiment.

FIG. 4C illustrates an exemplary solar roof tile, according to one embodiment.

FIG. 5A shows a top view of an exemplary multi-tile module, according to one embodiment.

FIG. 5B shows a top view of another exemplary solar roof tile, according to one embodiment.

FIG. 6 shows a partial view of a roof having a number of solar roof tiles and passive roof tiles.

FIGS. 7A-7B show roof-facing surfaces of photovoltaic roof tiles

FIG. 8A shows an exploded view of an exemplary junction box, according to one embodiment.

FIG. 8B shows a close-up view of cable terminals and a diode from the junction box depicted in FIG. 8A.

FIG. 8C shows a close-up view of cable terminal of a junction box, according to one embodiment.

FIG. 8D shows a close-up view of cable terminals assembled within a junction box body and a glands cap securing electrical leads and bypass cable within an entrance to the junction box body.

FIGS. 9A-9B show different views of a foot configured to bear the weight of at least a portion of a photovoltaic roof tile.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the disclosed system is not limited to the embodiments shown, but is to be accorded the widest scope consistent with the principles and features disclosed herein.

### Overview

Embodiments of the invention solve at least the technical problem of improving reliability, life span and safety of a photovoltaic roof tile installation. A solar roof tile (or PV roof tile) can include a number of solar cells sandwiched between a front glass cover and a back cover. While the circuitry housed within the photovoltaic roof tiles is well protected, cabling linking the photovoltaic roof tiles together is more susceptible to wear and degradation over time. Linking junction boxes of adjacent photovoltaic roof tiles together with multiple leads helps address this issue. In particular, using multiple cables to transfer energy between photovoltaic roof tiles cuts the amount of energy transported by each cable in half, which results improves a longevity of the cables. Furthermore, in the case that a cable does end up failing earlier than expected, the photovoltaic roof can still maintain a flow of energy between the photovoltaic roof tiles when each of the cables is of sufficient gauge to safely transfer an expected amount of energy between adjacent photovoltaic roof tiles.

In addition to adding a second cable linking the photovoltaic roof tiles together a junction box configuration with a safety component is described herein. The redundant cables both terminate at a single cable terminal within the junction box where during normal operation energy received from both cables is routed through internal circuitry of the photovoltaic roof tile. In cases where one or more circuits within the photovoltaic module are degraded and causing excess voltage buildup at the junction box, the safety component, which generally takes the form of a semiconductor diode allows energy received from the adjacent photovoltaic roof tile to bypass the current photovoltaic module so that degradation of a single photovoltaic roof tile result in the loss of other photovoltaic roof tiles that share the same region or row of a photovoltaic roof tile installation.

A “solar cell” or “cell” is a photovoltaic structure capable of converting light into electricity. A cell may have any size and any shape, and may be created from a variety of materials. For example, a solar cell may be a photovoltaic structure fabricated on a silicon wafer or one or more thin films on a substrate material (e.g., glass, plastic, or any other material capable of supporting the photovoltaic structure), or a combination thereof.

A “solar cell strip,” “photovoltaic strip,” “smaller cell,” or “strip” is a portion or segment of a photovoltaic structure, such as a solar cell. A photovoltaic structure may be divided into a number of strips. A strip may have any shape and any size. The width and length of a strip may be the same or different from each other. Strips may be formed by further dividing a previously divided strip.

“Finger lines,” “finger electrodes,” and “fingers” refer to elongated, electrically conductive (e.g., metallic) electrodes of a photovoltaic structure for collecting carriers.

“Busbar,” “bus line,” or “bus electrode” refer to elongated, electrically conductive (e.g., metallic) electrodes of a photovoltaic structure for aggregating current collected by two or more finger lines. A busbar is usually wider than a finger line, and can be deposited or otherwise positioned anywhere on or within the photovoltaic structure. A single photovoltaic structure may have one or more busbars.

A “photovoltaic structure” can refer to a solar cell, a segment, or a solar cell strip. A photovoltaic structure is not limited to a device fabricated by a particular method. For example, a photovoltaic structure can be a crystalline silicon-based solar cell, a thin film solar cell, an amorphous silicon-based solar cell, a polycrystalline silicon-based solar cell, or a strip thereof.

### PV Roof Tiles and Multi-Tile Modules

A PV roof tile (or solar roof tile) is a type of PV module shaped like a roof tile and typically enclosing fewer solar cells than a conventional solar panel. Note that such PV roof tiles can function as both PV cells and roof tiles at the same time. In some embodiments, the system disclosed herein can be applied to PV roof tiles and/or other types of PV module.

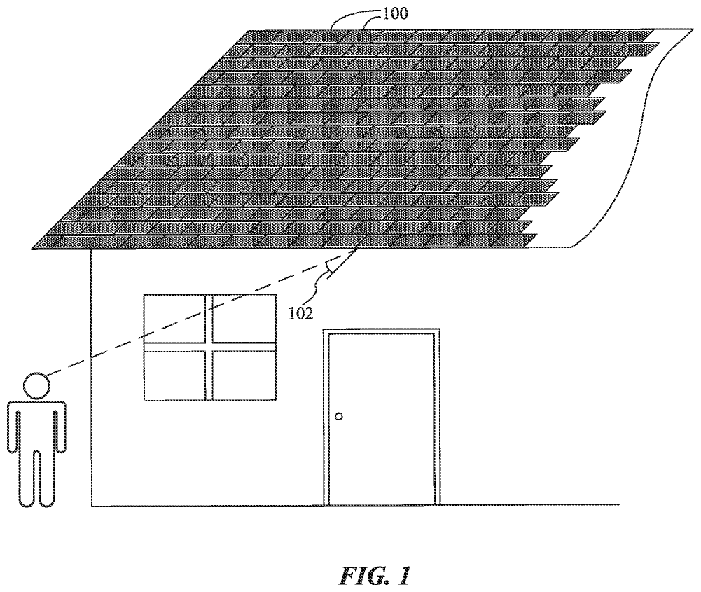

FIG. 1 shows an exemplary configuration of PV roof tiles on a house. PV roof tiles 100 can be installed on a house like conventional roof tiles or shingles. Particularly, a PV roof tile can be placed with other tiles in such a way as to prevent water from entering the building.

A PV roof tile can enclose multiple solar cells or PV structures, and a respective PV structure can include one or more electrodes, such as busbars and finger lines. The PV structures within a PV roof tile can be electrically and, optionally, mechanically coupled to each other. For example, multiple PV structures can be electrically coupled together by a metallic tab, via their respective busbars, to create serial or parallel connections. Moreover, electrical connections can be made between two adjacent tiles, so that a number of PV roof tiles can jointly provide electrical power. Cosmetic features of the PV roof tiles can allow the PV roof tiles to blend in and look the same as non-PV roof tiles. In some embodiments the cosmetic features can be designed to operate ideally when viewed from an angle 102.

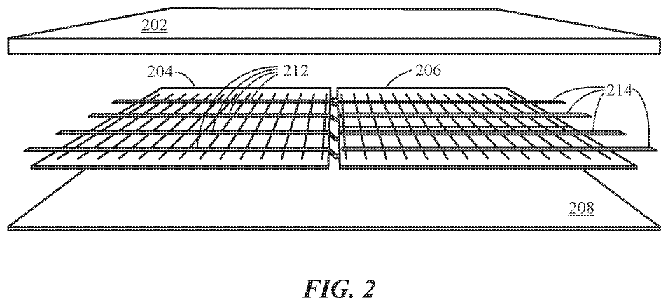

FIG. 2 shows a perspective view of an exemplary photovoltaic roof tile, according to an embodiment. Solar cells 204 and 206 can be hermetically sealed between top glass cover 202 and backsheet 208, which jointly can protect the solar cells from various weather elements. In the example shown in FIG. 2, metallic tabbing strips 212 can be in contact with the front-side electrodes of solar cell 204 and extend beyond the left edge of glass 202, thereby serving as contact electrodes of a first polarity of the PV roof tile. Tabbing strips 212 can also be in contact with the back of solar cell 206, creating a serial connection between solar cell 204 and solar cell 206. On the other hand, tabbing strips 214 can be in contact with front-side electrodes of solar cell 206 and extend beyond the right edge of glass cover 202, serving as contact electrodes of a second polarity of the PV roof tile. In some embodiments, backsheet 208 can be a standard backsheet formed from one or more layers of polymer such as, e.g., fluoropolymers or combinations of PET and EVA layers. Alternatively, backsheet 208 can take the form of a back glass cover.

In some embodiments, array of solar cells 204 and 206 can be encapsulated between top glass cover 202 and back cover 208. A top encapsulant layer, which can be based on a polymer, can be used to seal top glass cover 202 to array of solar cells 204/206. Specifically, the top encapsulant layer may include polyvinyl butyral (PVB), thermoplastic polyolefin (TPO), ethylene vinyl acetate (EVA), or N,N′-diphenyl-N,N′-bis(3-methylphenyl)-1,1′-diphenyl-4,4′-diamine (TPD). Similarly, a lower encapsulant layer, which can be based on a similar material, can be used to seal the array of solar cells to back cover 208. A PV roof tile can also contain other optional layers, such as an optical filter or coating layer or a layer of nanoparticles for providing desired color appearances. In the example of FIG. 2, module or roof tile 300 can also contains an optical filter layer between the array of solar cells and front glass cover 202.

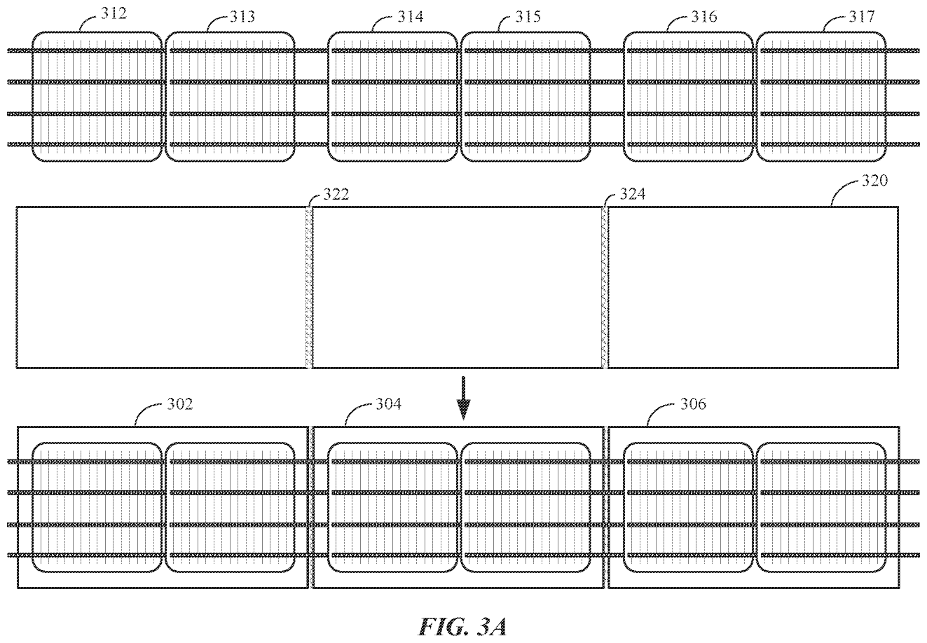

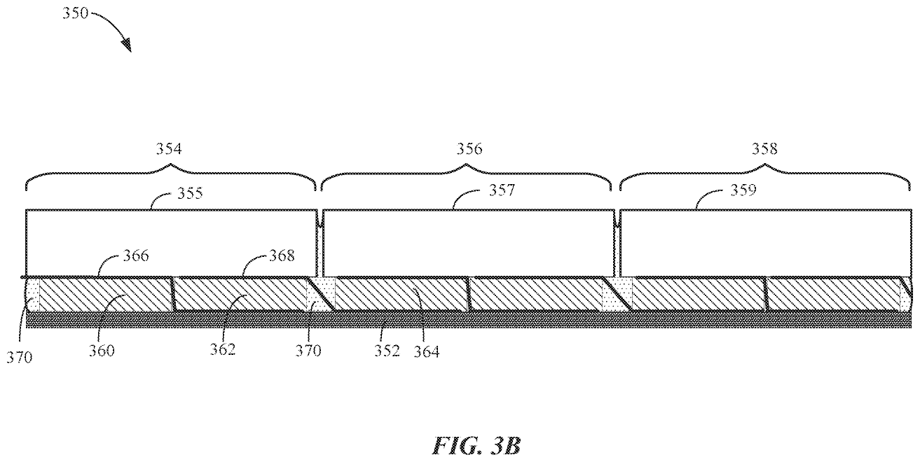

To facilitate more scalable production and easier installation, multiple photovoltaic roof tiles can be fabricated together, while the tiles are linked in a rigid or semi-rigid way. FIG. 3A illustrates an exemplary configuration of a multi-tile module, according to one embodiment. In this example, three PV roof tiles 302, 304, and 306 can be manufactured establishing a semi-rigid couplings 322 and 324 between adjacent tiles. Prefabricating multiple tiles into a rigid or semi-rigid multi-tile module can significantly reduce the complexity in roof installation, because the tiles within the module have been connected with the tabbing strips. Note that the number of tiles included in each multi-tile module can be more or fewer than what is shown in FIG. 3A.

FIG. 3B illustrates a cross-section of an exemplary multi-tile module, according to one embodiment. In this example, multi-tile module 350 can include photovoltaic roof tiles 354, 356, and 358. These tiles can share common backsheet 352, and have three individual glass covers 355, 357, and 359, respectively. Each tile can encapsulate two solar cells. For example, tile 354 can include solar cells 360 and 362 encapsulated between backsheet 352 and glass cover 355. Tabbing strips can be used to provide electrical coupling within each tile and between adjacent tiles. For example, tabbing strip 366 can couple the front electrode of solar cell 360 to the back electrode of solar cell 362, creating a serial connection between these two cells. Similarly, tabbing strip 368 can couple the front electrode of cell 362 to the back electrode of cell 364, creating a serial connection between tile 354 and tile 356.

Gaps 322 and 324 between adjacent PV tiles can be filled with encapsulant, protecting tabbing strips interconnecting the two adjacent tiles from the weather elements. For example, encapsulant 370 fills the gap between tiles 354 and 356, protecting tabbing strip 368 from weather elements. Furthermore, the three glass covers, backsheet 352, and the encapsulant together form a semi-rigid construction for multi-tile module 350. This semi-rigid construction can facilitate easier installation while providing a certain degree of flexibility among the tiles.

In addition to the examples shown in FIGS. 3A and 3B, a PV tile may include different forms of photovoltaic structures. For example, in order to reduce internal resistance, each square solar cell shown in FIG. 3A can be divided into multiple (e.g., three) smaller strips, each having edge busbars of different polarities on its two opposite edges. The edge busbars allow the strips to be cascaded one by one to form a serially connected string.

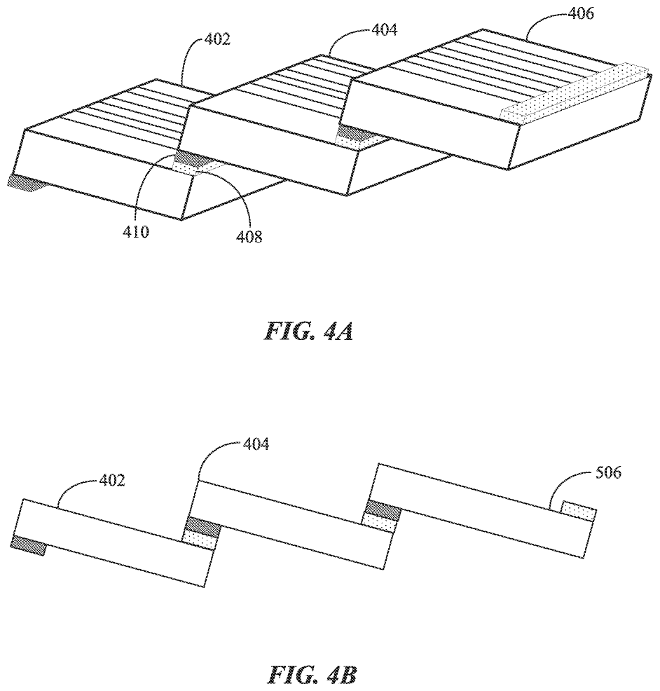

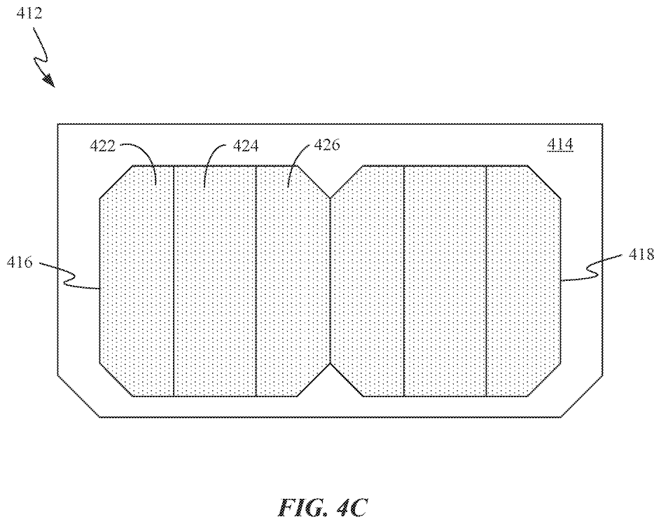

FIG. 4A illustrates a serial connection among three adjacent cascaded photovoltaic strips, according to one embodiment. In FIG. 4A, strips 502, 504, and 506 are stacked in such a way that strip 504 partially underlaps adjacent strip 506 to its right, and overlaps strip 502 to its left. The resulting string of strips forms a cascaded pattern similar to roof shingles. Strips 502 and 504 are electrically coupled in series via edge busbar 508 at the top surface of strip 502 and edge busbar 510 at the bottom surface of strip 504. Strips 502 and 504 can be arranged in such a way that bottom edge busbar 510 is above and in direct contact with top edge busbar 508. The coupling between strips 504 and 506 can be similar.

FIG. 4B illustrates a side view of the string of cascaded strips, according to one embodiment. In the example shown in FIGS. 4A and 4B, the strips can be segments of a six-inch square or pseudo-square solar cell, with each strip having a dimension of approximately two inches by six inches. To reduce shading, the overlapping between adjacent strips should be kept as small as possible. Therefore, in the example shown in FIGS. 4A and 4B, the single busbars (both at the top and the bottom surfaces) can be placed at or near the very edge of the strip. The same cascaded pattern can extend along multiple strips to form a serially connected string, and a number of strings can be coupled in series or parallel.

FIG. 4C illustrates an exemplary solar roof tile, according to one embodiment. A solar roof tile 412 includes top glass cover 414 and solar cells 516 and 518. The bottom cover (e.g., backsheet) of solar roof tile 412 is out of view in FIG. 4C. Solar cells 416 and 418 can be conventional square or pseudo-square solar cells, such as six-inch solar cells. In some embodiments, solar cells 416 and 418 can each be divided into three separate pieces of similar size. For example, solar cell 416 can include strips 422, 424, and 426. These strips can be arranged in such a way that adjacent strips are partially overlapped at the edges, similar to the ones shown in FIGS. 4A-4B. For simplicity of illustration, the electrode grids, including the finger lines and edge busbars, of the strips are not shown in FIG. 4C. In addition to the example shown in FIG. 4C, a solar roof tile can contain fewer or more cascaded strips, which can be of various shapes and size.

In some embodiments, multiple solar roof tiles, each encapsulating a cascaded string, can be assembled to obtain a multi-tile module. Inner-tile electrical coupling has been accomplished by overlapping corresponding edge busbars of adjacent strips. However, inter-tile electrical coupling within such a multi-tile module can be a challenge. Strain-relief connectors and long bussing strips have been used to facilitate inter-tile coupling. However, strain-relief connectors can be expensive, and arranging bussing strips after laying out the cascaded strings can be cumbersome. To facilitate low-cost, high-throughput manufacturing of the solar roof tiles, in some embodiments, metal strips can be pre-laid onto the back covers of the solar tiles, forming an embedded circuitry that can be similar to metal traces on a printed circuit board (PCB). More specifically, the embedded circuitry can be configured in such a way that it facilitates the electrical coupling among the multiple solar roof tiles within a multi-tile module.

Moreover, to facilitate electrical coupling between the embedded circuitry and an edge busbar situated on a front surface of a cascaded string, in some embodiments, a Si-based bridge electrode can be attached to the cascaded string. The Si-based bridge electrode can include a metallic layer covering its entire back surface and, optionally, a back edge busbar. By overlapping its edge (e.g., back edge busbar) to the front edge busbar of the cascaded string, the Si-based bridge electrode can turn itself into an electrode for the cascaded string, converting the forwardly facing electrode of the cascaded string to an electrode accessible from the back side of the cascaded string.

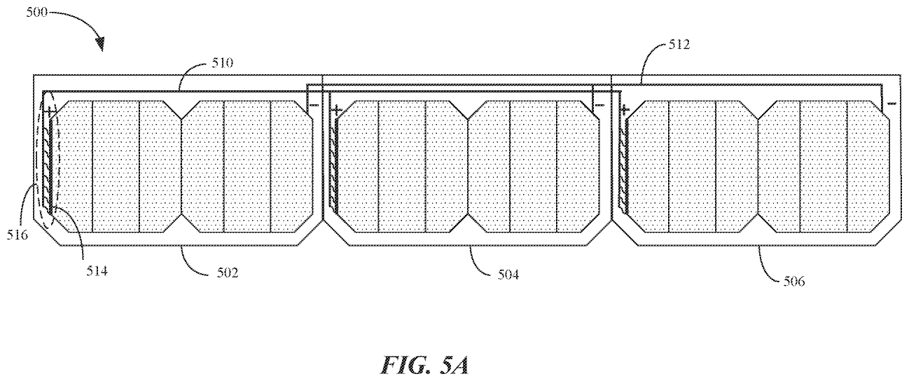

FIG. 5A shows a top view of an exemplary multi-tile module, according to one embodiment. Multi-tile module 600 can include PV roof tiles 502, 504, and 506 arranged side by side. Each PV roof tile can include six cascaded strips encapsulated between the front and back covers, meaning that busbars located at opposite edges of the cascaded string of strips have opposite polarities. For example, if the leftmost edge busbar of the strips in PV roof tile 502 has a positive polarity, then the rightmost edge busbar of the strips will have a negative polarity. Serial connections can be established among the tiles by electrically coupling busbars having opposite polarities, whereas parallel connections can be established among the tiles by electrically coupling busbars having the same polarity.

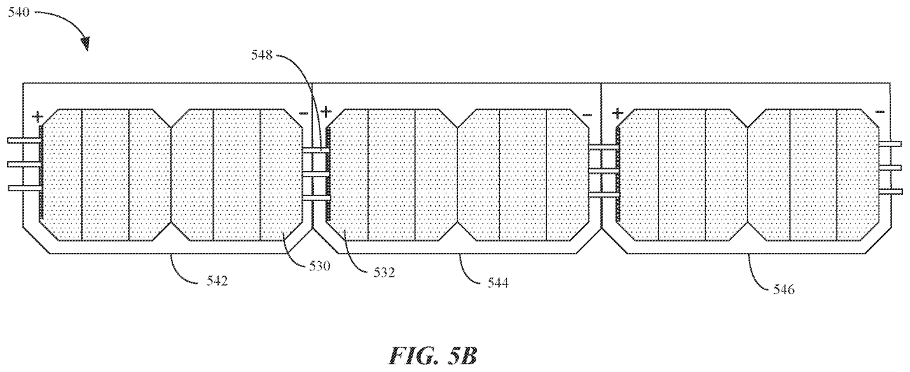

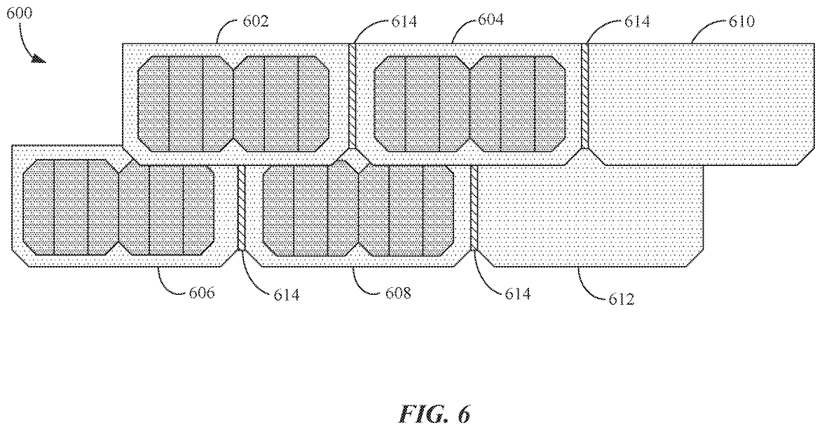

In the example shown in FIG. 5A, the PV roof tiles are arranged in such a way that their sun-facing sides have the same electrical polarity. As a result, the edge busbars of the same polarity will be on the same left or right edge. For example, the leftmost edge busbar of all PV roof tiles can have a positive polarity and the rightmost edge busbar of all PV roof tiles can have a negative polarity, or vice versa. In FIG. 6, the left edge busbars of all strips have a positive polarity (indicated by the “+” signs) and are located on the sun-facing (or front) surface of the strips, whereas the right edge busbars of all strips have a negative polarity (indicated by the “−” signs) and are located on the back surface. Depending on the design of the layer structure of the solar cell, the polarity and location of the edge busbars can be different from those shown in FIG. 5A.

A parallel connection among the tiles can be formed by electrically coupling all leftmost busbars together via metal tab 510 and all rightmost busbars together via metal tab 512. Metal tabs 510 and 512 are also known as connection buses and typically can be used for interconnecting individual solar cells or strings. A metal tab can be stamped, cut, or otherwise formed from conductive material, such as copper. Copper is a highly conductive and relatively low-cost connector material. However, other conductive materials such as silver, gold, or aluminum can be used. In particular, silver or gold can be used as a coating material to prevent oxidation of copper or aluminum. In some embodiments, alloys that have been heat-treated to have super-elastic properties can be used for all or part of the metal tab. Suitable alloys may include, for example, copper-zinc-aluminum (CuZnAl), copper-aluminum-nickel (CuAlNi), or copper-aluminum-beryllium (CuAlBe). In addition, the material of the metal tabs disclosed herein can be manipulated in whole or in part to alter mechanical properties. For example, all or part of metal tabs 510 and 512 can be forged (e.g., to increase strength), annealed (e.g., to increase ductility), and/or tempered (e.g. to increase surface hardness).

The coupling between a metal tab and a busbar can be facilitated by a specially designed strain-relief connector. In FIG. 5A, strain-relief connector 516 can be used to couple busbar 514 and metal tab 510. Such strain-relief connectors are needed due to the mismatch of the thermal expansion coefficients between metal (e.g., Cu) and silicon. As shown in FIG. 5A, the metal tabs (e.g., tabs 510 and 512) may cross paths with strain-relief connectors of opposite polarities. To prevent an electrical short of the photovoltaic strips, portions of the metal tabs and/or strain-relief connectors can be coated with an insulation film or wrapped with a sheet of insulation material.

In some embodiments, instead of parallelly coupling the tiles within a tile module using stamped metal tabs and strain-relief connectors as shown in FIG. 5A, one can also form serial coupling among the tiles. FIG. 5B shows the top view of an exemplary multi-tile module, according to one embodiment. Tile module 540 can include solar roof tiles 542, 544, and 546. Each tile can include a number (e.g., six) of cascaded solar cell strips arranged in a manner shown in FIGS. 4A and 4B. Furthermore, metal tabs can be used to interconnect photovoltaic strips enclosed in adjacent tiles. For example, metal tab 648 can connect the front of strip 632 with the back of strip 630, creating a serial coupling between strips 630 and 632. Although the example in FIG. 5B shows three metal tabs interconnecting the photovoltaic strips, other numbers of metal tabs can also be used. Furthermore, each solar roof tile can contain fewer or more cascaded strips, which can be of various shapes and sizes.

For simplicity of illustration, FIGS. 5A and 5B do not show the inter-tile spacers that provide support and facilitate mechanical and electrical coupling between adjacent tiles. Detailed descriptions of such inter-tile spacers can be found in U.S. Patent Publication US20190260328A1, entitled “INTER-TILE SUPPORT FOR SOLAR ROOF TILES,” the disclosure of which is incorporated herein by reference in its entirety.

### Color Matching in Solar Roof Tiles

As shown in FIG. 4C, FIG. 5A, and FIG. 5B, the photovoltaic structures and external electrodes encapsulated between the front and back covers can appear different than the background when viewed from the side of the transparent and colorless front cover. More specifically, the Si-based photovoltaic structures often appear to have a blue/purple hue. Although applying color onto the back cover can improve the color matching between the photovoltaic structures and the background, they cannot solve the problem of angle-dependence of color. In other words, the photovoltaic structures may appear to have different colors at different viewing angles, making color-matching difficult. Moreover, apart from solar roof tiles, a roof can sometimes include a certain number of “passive” or “dead” roof tiles, i.e., roof tiles that do not have embedded solar cells. These passive roof tiles can merely include the front and back covers and encapsulant sandwiched between the covers. The difference in appearance between the solar roof tiles and the passive roof tiles often results in a less pleasing aesthetic.

FIG. 6 shows a partial view of a roof having a number of solar roof tiles and passive roof tiles. In FIG. 6, roof 600 can include a number of roof tiles arranged in such a fashion that the lower edges of tiles in a top row overlap the upper edges of tiles in a bottom row, thus preventing water leakage. Moreover, the tiles are offset in such a manner that the gap between adjacent tiles in one row somewhat aligns with the center of a tile located in a different row. In the example shown in FIG. 6, tiles 602, 604, 606, and 608 are solar roof tiles, which can include photovoltaic structures encapsulated between front and back covers, and tiles 610 and 612 are passive roof tiles. As one can see from the drawing, the color contrast between the back covers and the photovoltaic structures can create a “picture frame” appearance of the solar roof tiles. In fact, the photovoltaic structures often appear to be “floating” above the colored back covers. Ideally, solar roof tiles 602-608 should have a similar appearance as passive roof tiles 610 and 612. Spacers 614 can fill gaps between adjacent tiles and prevent the passage of water between photovoltaic tiles 602-608. In some embodiments, spacers 614 can include electrical conductors that accommodate the passage of electricity and/or signals between adjacent photovoltaic tiles. In some embodiments, spacers 614 can define channels through which wires or similar conductors can carry the electricity and/or signals between the adjacent photovoltaic tiles.

### Photovoltaic Roof Tile Connection Configuration

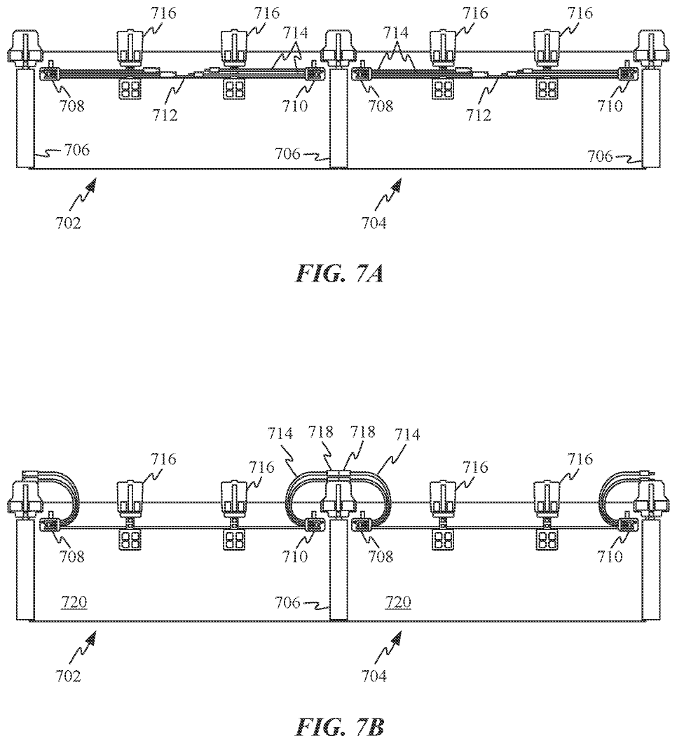

FIGS. 7A-7B show roof-facing surface of adjacent photovoltaic roof tiles and an electrical lead configuration for coupling the adjacent photovoltaic roof tiles together. FIG. 7A depicts photovoltaic roof tiles 702 and 704 mechanically coupled together by a spacer foot 706. In some embodiments, the mechanical coupling can take the form of a slot on opposing sides of the spacer foot having a height and width corresponding to one end of the photovoltaic roof tiles. Spacer foot 706 can also be configured to prevent the passage of water between adjacent photovoltaic roof tiles 702 and 704. Spacer foot 706 will also generally include fastener openings for affixing photovoltaic roof tiles to a rooftop batten to keep photovoltaic modules 702 and 704 in place atop a rooftop. Each of photovoltaic roof tiles 702 and 704 includes junction boxes 708 and 710 at opposing ends of the PV roof tile modules. Junction boxes 708 are configured to receive power generated by adjacent photovoltaic roof tiles and route that power through circuitry of the photovoltaic roof tile. In the event the photovoltaic roof tile is malfunctioning or for some reason unable to output power, junction box 708 includes an electrical component that routes the power generated by the adjacent photovoltaic module or modules through bypass cable 712, which electrically couples junction boxes 708 and 710 directly together. In some embodiments, the electrical component can take the form of a diode. The diode allows electrical energy arriving at junction box 708 of the photovoltaic roof tile to bypass internal circuitry of the photovoltaic roof tile by travelling directly to junction box 710 through bypass cable 712 when a voltage within the internal circuitry exceeds a predetermined threshold. Typically, this predetermined threshold will be set to allow the bypass when the voltage is at a level that raises the potential for unsafe operations where electrical arcing or other electrical issues could arise.

During normal operation of one of the photovoltaic roof tiles, junction box 710 is configured to receive the energy from the adjacent photovoltaic roof tiles routed through the internal circuitry of the photovoltaic roof tile as well as any energy generated by solar cells of the photovoltaic roof tile. Junction box 710 includes dual electrical leads 714 for outputting the energy received at junction box 710 to an adjacent photovoltaic roof tile. In FIG. 7A, leads 714 are shown attached to cable management features of feet 716. The cable management features of feet 716 keep leads 714 from flapping around during transit and/or installation. Feet 716 operate primarily to support a central region of a photovoltaic roof tile and can include fastener openings for securing each foot 716 to a rooftop batten or directly to a roofing substrate.

FIG. 7B shows electrical leads 714 disengaged from the retention features of feet 716 and coupled together in front of spacer foot 706 to provide a redundant electrical coupling between adjacent photovoltaic roof tiles 702 and 704. In addition to providing a backup connector, the redundant electrical coupling also reduces the amount of electrical energy that each of leads 714 must carry over a life of the photovoltaic roof tile installation thereby substantially extending an expected life of electrical leads 714. The configuration depicted in FIG. 7B also allows for convenient access by installers to electrical leads 714 after attachment of photovoltaic roof tiles modules 702 and 704 to a roof top. This configuration also allows installers to inspect the connection of electrical leads 714. In some embodiments, connectors 718 can be male female type connectors that electrically connect by inserting the male connector 718 into the female connector 718. It should be noted that photovoltaic modules 702 and 704 can take many forms including the ones depicted in FIGS. 3B and 4C. In some embodiments, the roof-facing surface 720 of the photovoltaic roof tiles can be the surface of a backsheet formed from polymeric material, semiconductor material, glass, or the like.

While electrical leads 714 are shown connecting in a specific way in FIG. 7B it should be appreciated that leads 714 could have many other configurations. For example, leads 714 could instead extend from opposite sides of each of the junction boxes, so instead of looping around spacer 706 leads 714 extend beneath spacer 706, thereby substantially reducing a length of each of leads 714. In some embodiments, electrical leads 714 only protrude from junction box 710 or junction box 708. In such a configuration, electrical leads 714 could attach to an external terminal on an exterior of the junction box that doesn't include the protruding electrical leads 714. It should also be noted that while a fixed number of feet 716 are depicted supporting each of the photovoltaic modules that a larger or smaller number of feet 716 are possible based on a size of each of the photovoltaic roof tiles.

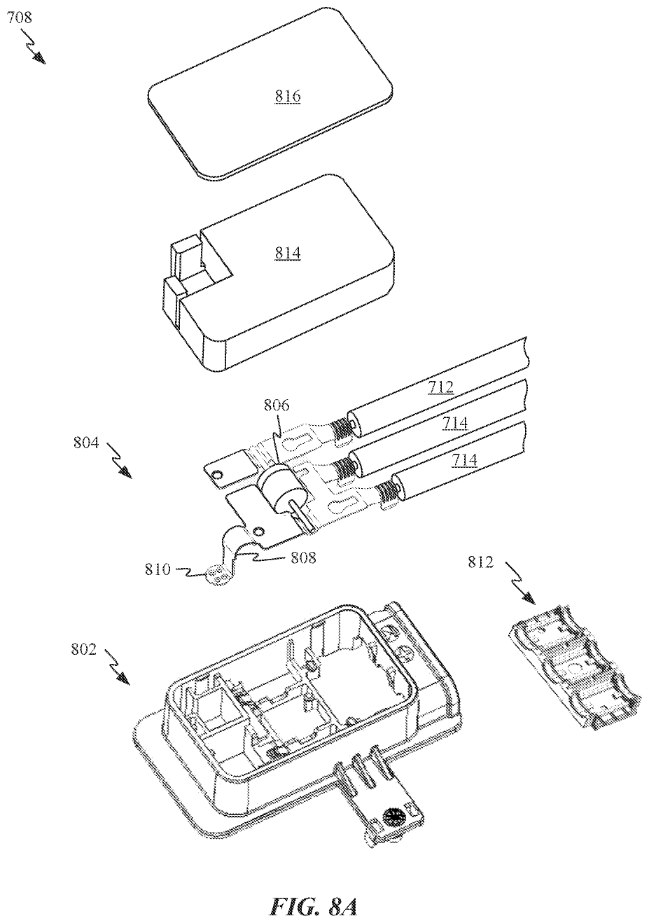

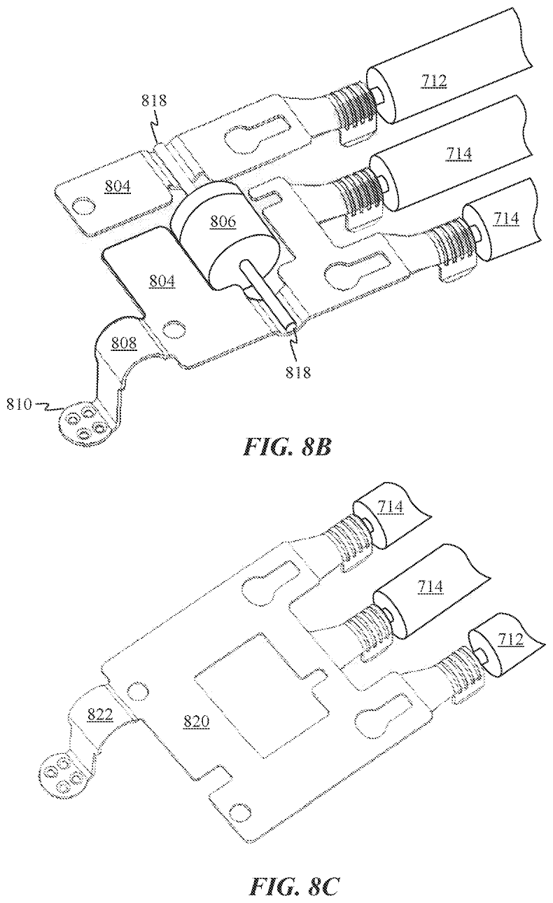

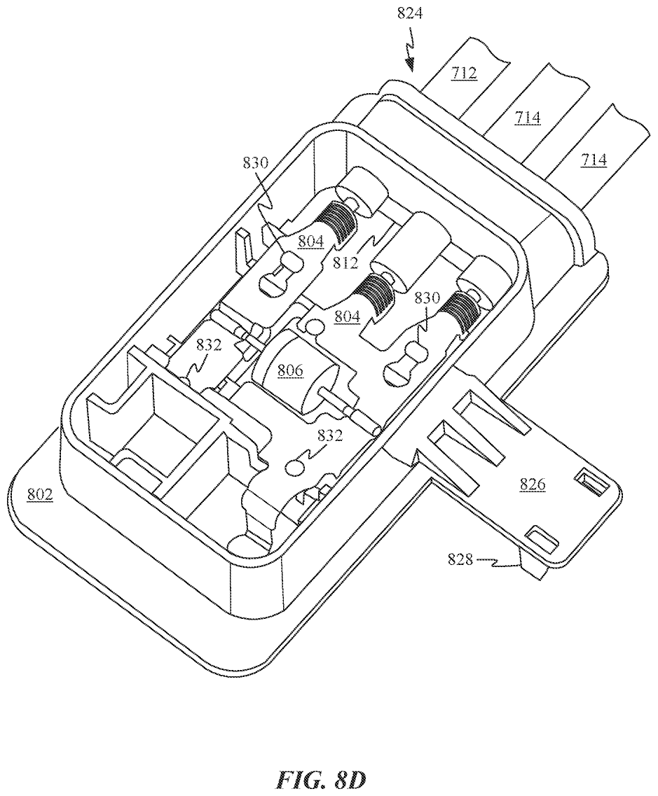

FIG. 8A shows an exploded view of one of junction boxes 708. As depicted, junction box 708 includes junction box body 802. Junction box body 802 can be formed of an electrically insulating material such as plastic and includes multiple recesses configured to accommodate and facilitate positioning of cable terminals 804 within junction box body 802. Junction box body 802 can also include one or more fastener openings for receiving fasteners that secure cable terminals 804 securely within junction box body 802. FIG. 8A also depicts diode 806, which electrically couples terminals from electrical leads 714 with a terminal of bypass cable 712. Cable terminals 804 of electrical leads 714 are merged together allowing electrical energy arriving from an adjacent photovoltaic roof tile to be equally distributed across electrical leads 714 and then during normal operations to be routed into internal circuitry of the photovoltaic roof tile by flexible connector 808. Flexible connector 808 has a curved geometry that allows some flexure of flexible connector 808 to accommodate minor variations in positioning of cable terminals 804 within junction box body 802 and shifting of electrical pad 810 to facilitate easy connection of electrical pad 810 to internal circuitry of the photovoltaic roof tile.

FIG. 8A also shows glands cap 812, which mechanically couples with a module facing surface of junction box body 802 to secure and protect the ends of bypass cable 712 and electrical leads 714 within an entryway of junction box body 802. Glands cap 812 includes a first recess for bypass cable 712, a second recess for a first one of electrical leads 714 and a third recess for a second one of electrical leads 714.

FIG. 8A also depicts pottant material 814 in the shape it assumes when cured within junction box 802. After securing cable terminals 804 within junction box body 802, securing glands cap 812 to junction box body 802 and attaching junction box body 802 to the photovoltaic roof tile, an interior of junction box 802 can be filled with pottant material 814. Pottant material 814 can take the form of a rapid curing silicone material configured to dissipate heat generated at cable terminals 804 and by diode 806 during operation of junction box 708. Since pottant 814 is applied in a liquid state it is able to flow into and conform to the shape of junction box body 802 and cable terminals 804 prior to curing. In addition to helping manage thermal heat dissipation, pottant 814 is also operative to keep components within junction box body 802 in place. FIG. 8A also shows a lid 816 of junction box 708, which can be used to close an opening in the top of junction box body 802 in order to further shield and protect components within junction box 708.

FIG. 8B shows a close-up view of cable terminals 804 and diode 806 of junction box 708. In particular, FIG. 8B shows how each of cable terminals 804 can include aligned recessed curvatures that forms a bearing that facilitates the positioning of diode terminals 818 on cable terminals 804. Diode terminals 818 can be soldered to cable terminals 804, which secures diode terminals 818 in place and can also improve an electrical coupling between diode terminals 818 and cable terminals 804. Cable terminals 804 can be formed by a metal stamping operation. The aligned recesses defining the bearing for diode terminals 818 and the curved flexible connector 808 can both be formed by bending the stamped material to achieve the geometry depicted in FIG. 8B. A thickness of the stamped material can be selected to achieve a desired flexibility of flexible connector 808 and be of sufficient thickness to carry an amount of electrical energy the solar cells of the photovoltaic roof tiles are expected to generate.

FIG. 8B also shows how cable terminal 804 associated with electrical leads 714 includes a cut-out region having a shape and size suitable for accommodating placement of diode 806 between cable terminals 804. In some embodiments, instead of including aligned recesses to define a bearing for diode terminals 818, diode terminals can each form a right angle that helps prevent rotation of diode 806 when placed upon cable terminals 804. After placement of the diode terminals with right angled geometry, each of the diode terminals can be soldered to cable terminals 804.

FIG. 8C shows a close-up view of cable terminal 820 of junction box 710. Junction box 710 can have similar features to junction box 708 with the exception that electrical leads 714 and bypass cable share a single cable terminal 820 within junction box 710. During normal operation of an associated photovoltaic roof tile, electrical energy generated by the associated photovoltaic roof tile as well as any energy generated by adjacent photovoltaic roof tiles would enter cable terminal 820 through flexible connector 822. Where the photovoltaic roof tile is degraded, at least some of the electrical energy from adjacent photovoltaic roof tiles can flow through bypass cable 712. While a majority of the electrical energy entering cable terminal 820 in the degraded state enters through bypass cable 712 some energy generated by the photovoltaic roof tile can enter through flexible connector 822. Electrical energy entering cable terminal 820 is then routed to the next adjacent photovoltaic module through electrical leads 714. In a case where one of electrical leads 714 is degraded or where one of electrical leads 714 has become unconnected, electrical energy can continue flowing and providing power to an owner of the system that includes the associated photovoltaic roof tile. While in the event of a failure of one of electrical leads 714 the voltage running through the single electrical lead 714 would be doubled, electrical lead 714 can be sized to accommodate the entire load being offloaded from the photovoltaic roof tile.

FIG. 8D shows a close-up view of cable terminals 804 assembled within junction box body 802 and glands cap 812 securing electrical leads 714 and bypass cable 712 within an entrance 824 to junction box body 802. Junction box body 802 includes location clip arm 826, which includes location clips 828, which are configured to engage openings in a roof-facing surface of a photovoltaic roof tile. The openings engaged by location clips 828 are located to precisely position junction box body 802 in a desired location on the roof-facing surface of the photovoltaic roof tile when location clips 828 engage the openings. Location clips 828 acting through location clip arm also helps to keep junction box body 802 in place while junction box body 802 is being adhesively coupled to the roof-facing surface of the photovoltaic roof top module.

FIG. 8D also shows fasteners 830 affixing cable terminals 804 to junction box body 802. In some embodiments, fasteners 830 can take the form of tabs that slidably engage fastener openings in cable terminals 804. Alternatively, fasteners 830 can take the form of conventional fasteners, such as screws. Cable terminals 804 can also be affixed to junction box body 802 by fasteners 832, which extend through fastener openings sized smaller than a size of a head of each of fasteners 832.

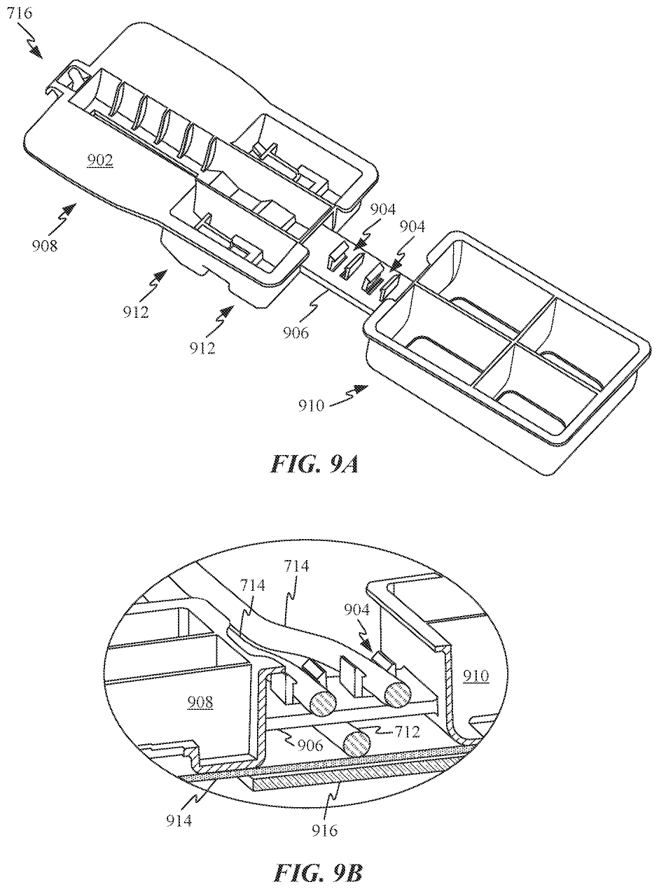

FIGS. 9A-9B show different views of foot 716. FIG. 9A shows a perspective view of foot 716 that primarily shows a surface 902 of foot 716 that contacts a surface of a roof substrate or roof battens. FIG. 9A also shows a position of cable retention features 902 on bridge element 904. Bridge element 904 joins a front foot portion 908 to a rear foot portion 910. Front portion 906 includes multiple protrusions 912 for engaging openings in a backsheet of a photovoltaic roof tile that help locate and keep foot 716 stationary during attachment of foot 716 to the photovoltaic roof tile. When foot 716 is adhesively attached to the photovoltaic roof tile, engagement of the photovoltaic roof tiles by protrusions 912 can ameliorate any shearing forces that might otherwise eventually lead to the failure of the adhesive bond.

FIG. 9B shows a close-up partial cross-sectional view of the portion of foot 716 that includes bridge element 904 when it is attached to a backsheet 910 of a photovoltaic roof tile. The photovoltaic roof tile is also depicted including solar cell 912. It should be noted that while only backsheet 910 and solar cell 912 are shown in this embodiment, the photovoltaic roof tile has a more complex architecture that includes front and back covers as well as encapsulant to keep solar cells 912 in place and protected.

FIG. 9B also shows how electrical leads 714 are shown in a storage position being retained by cable management features 902. Bypass cable 712 is routed beneath bridge element 904, protruding through a channel defined by bridge element 904, backsheet 910 and front and back foot portions 908 and 910. In this way, foot 716 can be configured to keep a portion of bypass cable 712 fixed in place. In some embodiments a distance between bridge element 904 and backsheet 914 can be about the same as or slightly less than a diameter of bypass cable 712 to further discourage movement of bypass cable 712.

The foregoing descriptions of various embodiments have been presented only for purposes of illustration and description. They are not intended to be exhaustive or to limit the present system to the forms disclosed. Accordingly, many modifications and variations will be apparent to practitioners skilled in the art. Additionally, the above disclosure is not intended to limit the present system.

What is claimed is:

1. A photovoltaic roof tile, comprising:
a protective cover;
a backsheet;
a plurality of solar cells disposed between the protective cover and the backsheet, the plurality of solar cells comprising a first electrical terminal proximate a first end of the photovoltaic roof tile and a second electrical terminal proximate a second end of the photovoltaic roof tile;
a first junction box adhered to a roof-facing surface of the backsheet, the first junction box comprising:
a first cable terminal comprising a first end electrically coupled to the first electrical terminal and a second end electrically coupled to a first electrical lead and a second electrical lead configured to receive electrical energy in parallel from an adjacent photovoltaic roof tile;
a second cable terminal; and
a diode electrically coupling the first cable terminal to the second cable terminal;
a second junction box adhered to the roof-facing surface of the backsheet, the second junction box comprising a third cable terminal electrically coupled to the second electrical terminal and configured to receive electrical energy generated by the plurality of solar cells; and
a bypass cable comprising a first cable end at the second cable terminal and a second cable end at the third cable terminal.

2. The photovoltaic roof tile as recited in claim 1, wherein the photovoltaic roof tile is a first photovoltaic roof tile and the adjacent photovoltaic roof tile is a second photovoltaic roof tile, wherein the second photovoltaic roof tile is mechanically coupled to the first photovoltaic roof tile and electrically coupled to the first photovoltaic roof tile using the first and second electrical leads.

3. The photovoltaic roof tile of claim 1, wherein the plurality of solar cells comprises a first edge busbar positioned near an edge of a first surface and a second edge busbar positioned near an opposite edge of a second surface, and wherein the plurality of solar cells are arranged in such a way that the first edge busbar of a first solar cell overlaps the second edge busbar of an adjacent solar cell, thereby resulting in the plurality of solar cells forming a serially coupled string.

4. The photovoltaic roof tile of claim 1, wherein the diode is configured to allow electrical energy received at the first cable terminal to flow across the diode and into the second cable terminal when a predetermined threshold voltage is reached at the first cable terminal.

5. The photovoltaic roof tile of claim 4, wherein the predetermined threshold voltage is greater than a normal operating voltage of the photovoltaic roof tile and the diode is configured to prevent electrical arcing when one or more circuits associated with the plurality of solar cells is degraded.

6. The photovoltaic roof tile of claim 4, wherein the first cable terminal is separate and distinct from the second cable terminal.

7. The photovoltaic roof tile of claim 1, wherein the diode directs electrical energy received at the first cable terminal to the second cable terminal and across the bypass cable when an electrical voltage at the first cable terminal exceeds a predetermined threshold value.

8. The photovoltaic roof tile of claim 1, wherein the first cable terminal defines a cut-out region that accommodates positioning the diode between the first and second cable terminals.

9. The photovoltaic roof tile of claim 1, further comprising a foot configured to support at least a portion of a weight of the photovoltaic roof tile upon a roof top, wherein the foot comprises cable management features configured to secure the first and second leads to the photovoltaic roof tile.

10. The photovoltaic roof tile of claim 1, further comprising a foot configured to support at least a portion of a weight of the photovoltaic roof tile upon a roof top, wherein the bypass cable is routed between a portion of the foot and the backsheet.

11. A photovoltaic roof, comprising:
a first photovoltaic roof tile comprising a first junction box;
a second photovoltaic roof tile adjacent to the first photovoltaic roof tile, the second photovoltaic roof tile comprising:
a second junction box;
a third junction box; and
a diode, wherein internal circuitry of the second photovoltaic roof tile electrically couples a first cable terminal within the second junction box to a second cable terminal within the third junction box;
a first cable electrically coupling the first junction box to the second junction box;
a second cable electrically coupling the first junction box to the second junction box in parallel with the first cable; and
a third cable electrically coupling the second junction box to the third junction box, wherein the diode directs electrical energy received from the first junction box at the second junction box across the third cable when an electrical voltage at the second junction box exceeds a predetermined threshold value.

12. The photovoltaic roof as recited in claim 11, wherein the third cable is external to the second photovoltaic roof tile.

13. The photovoltaic roof as recited in claim 11, wherein the diode is electrically coupled directly to the first cable terminal and to a third cable terminal disposed within the second junction box.

14. The photovoltaic roof as recited in claim 13, wherein a first cable end of the third cable is at the third cable terminal and a second cable end of the third cable is at the second cable terminal.

15. The photovoltaic roof as recited in claim 11, wherein the internal circuitry comprises a plurality of solar cells, circuitry associated with the plurality of solar cells, a first electrical terminal and a second electrical terminal.

16. The photovoltaic roof as recited in claim 15, wherein the second cable terminal comprises a first flexible connector that extends through a first opening defined by a backsheet of the second photovoltaic roof tile and electrically couples the second cable terminal to the first electrical terminal.

17. The photovoltaic roof as recited in claim 16, wherein a second cable terminal comprises a second flexible connector that extends through a second opening defined by the backsheet and electrically couples the second cable terminal to the second electrical terminal.

18. The photovoltaic roof as recited in claim 17, wherein the second junction box is closer to the first photovoltaic roof tile than the third junction box.

19. The photovoltaic roof as recited in claim 11, further comprising a spacer foot directly coupled to the first photovoltaic roof tile and the second photovoltaic roof tile, wherein the spacer foot is configured to support at least a portion of a weight of the first photovoltaic roof tile and the second photovoltaic roof tile.

20. The photovoltaic roof as recited in claim 19, wherein the first and second cables are routed around a forward portion of the spacer foot.
